(19) United States
(12) Patent Application Publication
(10) Pub. No.: US 2009/0070285 A1
(43) Pub. Date: Mar. 12, 2009

(54) DATA MANAGEMENT SYSTEM, COMMUNICATION TERMINAL, AND METHOD FOR MANAGING DATA

(76) Inventor: Makoto Kobayashi, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/588,367

(22) PCT Filed: Jan. 26, 2005
(86) PCT No.: PCT/JP2005/000957

§ 371 Date: Nov. 7, 2008

(30) Foreign Application Priority Data
Feb. 5, 2004 (JP) 2004-029207

(51) Int. Cl. G06F 17/30

(52) U.S. Cl. 707/1; 707/100; 707/E17.044; 707/E17.001

(57) ABSTRACT

Metadata corresponding to content data respectively stored in plural communication terminals can be retrieved easily.

When any of the following three cases occurs:
(a) any of communication terminal A to E is connected to another communication terminal,
(b) an addition, a deletion, or a replacement of content data 30 stored in a content data storage 3 is produced, and
(c) a communication terminal has received metadata 20 from another communication terminal connected to the communication terminal,
   a metadata stored 20 in the metadata storage 2 gets updated and the updated metadata 20, if the communication terminal is connected to another upper level communication terminal, gets transmitted to the upper level communication terminal.

### BACKGROUND

1. Field

One embodiment of the invention relates to a data management system, a communication terminal, and a data management method which manage metadata indexing attribute information about locations, content types, etc. of content data such as texts, images, sounds, or the like, and in particular, to a data management system, a communication terminal, and a data management method for easily and promptly obtaining the metadata and easily performing a hierarchical management of the metadata with a simple structure.

2. Description of the Related Art

The present application is based on Japanese patent application No. 2004-029207, the entire contents of which are incorporated herein by reference.

In recent years plural host computers are connected each other through communication networks such as ISDN (Integrated Services Digital Network), ADSL (Asymmetric Digital Subscriber Line), wireless-LAN (Local Area Network), and a content data-sharing system, in which content data composed by respective formats corresponding to texts, images, movies, or sounds are shared among plural host computers hooked on the network, is suggested.

In the content data-sharing system as stated above, for example, both the content data and metadata defining attribute information on the locations, content types, and formats of the content data are stored in a hard disk drive which is a magnetic disk device installed in a host computer. The host computer connected to a network, by referring to metadata stored in other host computers, specifies a host computer which stores desired content data and obtains the information with regard to the location of the desired content data to access the indexed location of the hard disk drive in the specified host computer.

Meanwhile, there is an information-collecting system with a metadata storage, wherein a communication terminal stores metadata in it (refer to Japanese Unexamined Patent Publication No. 2003-163847 (Paragraph [0048], FIG. 1)).

The information-collecting system stated in the referred document includes a first communication section connected to a network, a selection section which selects received information by the first communication section corresponding to preference data stored in a preference data storage in advance, a storage which stores content data as the received information selected in the selection section and metadata to index attribute information of the content data respectively, a communication terminal with a second communication section to wirelessly communicate with a portable terminal, and a portable terminal to wirelessly communicate with the second communication section of the communication terminal.

With the information-collecting system stated in the referred document, when the portable terminal and the communication terminal recognize each other that the portable terminal is in the wireless communication area of the second communication section, user's preference data can be stored in the preference data storage by sending the preference data that shows the user's preference obtained by the portable terminal itself or the information about recorded programs viewed on the portable terminal itself, namely the metadata to the second communication section of the communication terminal based on user's instructions from an operation section of the portable terminal or the communication terminal. Consequently the user's preference data, for example, user's favorite programs can be stored without fail.

In the information-collecting system stated in the referred document, however, as an entire system, the metadata are dispersed because the communication terminal stores each metadata corresponding to each content data that the communication terminal stores by itself. As a result, in a certain case, all the metadata respectively stored in every communication terminal on the network should be retrieved for a desired content data. Besides, it is inconvenient that some content data are stored redundantly. In addition, since, as the entire system, the metadata are stored dispersedly, in case one communication terminal on the network is inaccessible due to malfunctions or the like the metadata of the one communication terminal can't be obtained.

### DISCLOSURE OF INVENTION

It is an object of the present invention to provide a data management system, a communication terminal, and a data management method, which can easily retrieve metadata.

In order to attain the above-described object the present invention provides, a data management system comprises,

a first communication terminal including a first content data storage to store a first content data and a first related data storage to store a first related data corresponding to the first content data, and

a second communication terminal including a second content data storage to store a second content data and a second related data storage to store the first related data received from the first communication terminal through the network and a second related data corresponding to the second content data.

In addition, in order to attain the above-described object the present invention provides,

a data management system, comprises,

a group of a plurality of communication terminals connected with each other; and

a browsing communication terminal to be connected to one communication terminal of the group, wherein:

the browsing communication terminal is connected to an uppermost level communication terminal of the group through the one communication terminal and a communication terminal between the one communication terminal and the uppermost level communication terminal;

the browsing communication terminal retrieves a related data corresponding to a desired content data from the related data stored in the uppermost communication terminal to identify an communication terminal of the group which stores the desired content data; and

the browsing communication terminal communicates with the identified communication terminal to receive the desired content data, and then plays back the desired content data.

In addition, in order to attain the above-described object the present invention provides,

a communication terminal comprises,

a content data storage to store a first content data, and

a related data storage to receive/store a first related data corresponding to the first content data and a second related data corresponding to a second content data stored in another communication terminal through a network.

In addition, in order to attain the above-described object the present invention provides,

a communication terminal, comprising:

a content data storage to store content data; and

a related data storage to store the related data corresponding to the content data;

a communication section to send and receive the related data with other communication terminals;

a control section to control the communication section wherein:

the control section, when the other communication terminal is connected to the communication terminal, updates the related data stored in the related data storage, and transmits the updated related data to an upper level communication terminal by controlling the communication section.

In addition, in order to attain the above-described object the present invention provides,

a communication terminal comprises,

a related data storage to store related data corresponding to a content data,

an input section to input retrieval information of the desired content data for browsing,

a related data retrieval section to find the related data stored in the related data storage based on the retrieval information, and

a browsing section to browse the content data corresponding to the related data retrieved by the related data retrieval section.

In addition, in order to attain the above-described object the present invention provides,

a communication terminal, comprising:

a related data storage to store related data corresponding to a content data;

an input section to input retrieval information of the desired content data for browsing;

a related data retrieval section to retrieve the related data stored in the related data storage based on the retrieval information;

a browsing section to browse the content data corresponding to related data retrieved by the related data retrieval section;

a communication section to receive the content data and the related data through network; and

a control section to control the communication of the content data based on the retrieved related data.

In addition, in order to attain the above-described object the present invention provides,

a data management method includes the steps of,

a first storage step of storing a first related data corresponding to a first content data, and

a second storage step of storing a second related data corresponding to a second content data stored in another terminal.

In addition, in order to attain the above-described object the present invention provides,

a data management method comprises the steps of:

connecting a first communication terminal to a second communication terminal as an upper level communication terminal;

when a new content data is inputted to the first communication terminal, storing the new content data in a content data storage of the first communication terminal and storing a related data corresponding to the stored content data;

updating an existing first related data of the related data storage based upon the stored related data;

transmitting the first updated related data to the second communication terminal from the first communication terminal based upon a communication approval from the second communication terminal;

storing the first related data transmitted from the first communication terminal in the related data storage of the second communication terminal; and

updating an existing related data of the related data storage in the second communication terminal based upon storage of the first related data transmitted.

In addition, in order to attain the above-described object the present invention provides,

a data management method includes the steps of,

a storage step of storing metadata received through a network,

an input step of inputting retrieval information on a desired content data for browsing,

a retrieval step of retrieving the stored metadata based on the retrieval information, and

a browsing step of browsing the content data corresponding to the stored metadata retrieved at the retrieval step through the network.

According to the present invention, metadata corresponding to content data respectively stored in plural communication terminals can be retrieved easily.

### BRIEF DESCRIPTION OF THE SEVERAL VIEWS OF THE DRAWINGS

FIG. 1 is an exemplary entire view showing a data management system with communication terminals in a first preferred embodiment according to an embodiment of the invention;

FIG. 2 is an exemplary circuit block diagram showing a main section of each communication terminal A to E in the embodiment;

FIG. 3 is an exemplary flowchart showing an operation between the communication terminal B and the communication terminal D in the embodiment;

FIG. 4 is an exemplary chart showing a communication terminal F which newly joins the data management system in the embodiment;

FIG. 5 is an exemplary flowchart of an operation in the first preferred embodiment according to an embodiment of the present invention;

FIG. 6 is an exemplary view showing the data management system with a state of storing a metadata F1M of the communication terminal F in a metadata storage of the communication terminal A in the embodiment;

FIG. 7 is an exemplary timing chart showing a flow of updating metadata when a content data gets added to the communication terminal F in the embodiment;

FIG. 8 is an exemplary timing chart showing a flow of updating metadata when a content data stored in the communication terminal F gets deleted in the embodiment;

FIG. 9 is an exemplary entire view showing a data management system with communication terminals in a second preferred embodiment according to an embodiment of the invention;

FIG. 10 is an exemplary circuit block diagram showing a main section of a communication terminal G in the embodiment;

FIG. 11 is an exemplary flowchart of an operation in the second preferred embodiment according to the embodiment;

FIG. 12 is an exemplary view showing the communication terminal G, with a state of storing uppermost metadata in its received metadata storage, connected to the communication terminal F by peer-to-peer in the embodiment; and

FIG. 13 is an exemplary peer-to-peer communication flow between the communication terminal G and the communication terminal F in the embodiment.

### DESCRIPTION OF THE SYMBOLS

1 DATA MANAGEMENT SYSTEM
2 METADATA STORAGE SECTION
3 CONTENT DATA STORAGE SECTION
4 MEMORY
5 COMMUNICATION SECTION
6 CONTROL SECTION
20 METADATA
30 CONTENT DATA
40 DESIRED DATA INPUT SECTION
41 METADATA RETRIEVAL SECTION
42 RECEIVED METADATA STORAGE SECTION
43 BROWSING SECTION
44 CONTROL SECTION
50 ANTENNA
A to G COMMUNICATION TERMINAL

### DETAILED DESCRIPTION

Various embodiments according to the invention will be described hereinafter with reference to the accompanying drawings. In the following section a first embodiment and a second embodiment of the present invention with regard to a data management system, a communication terminal, and a data management method will be explained. The first preferred embodiment relates to constructing a data management system that efficiently manages metadata by a single communication terminal and the second preferred embodiment relates to utilizing content data based on metadata stored in a data management system.

### First Preferred Embodiment

### (Configuration of a Data Management System)

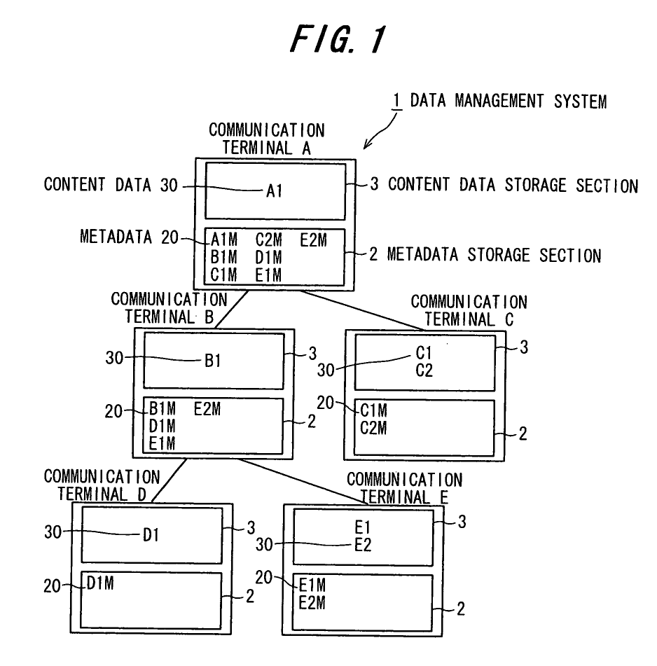

FIG. 1 is an entire view showing a data management system with communication terminals in the first preferred embodiment according to the present invention. FIG. 1 shows the data management system 1 including a plurality of communication terminals A to E allocated in the shape of a tree which can wirelessly send/receive data. These communication terminals, for instance, are personal computers, and each of them includes a metadata storage 2 which stores metadata 20 indexing attribute information about the locations, content-types, etc. of content data such as texts, images, movies, sounds, or the like, and a content data storage 3 which stores content data 30.

The metadata storage 2, for instance, is composed of a hard disk, which can read/write content data 30 and stores metadata 20 indexing attribute information of the content data 30 with a text- or binary-format in a memory area on the hard disk. Now as the metadata 20, for example, a metadata A1M is explained, the beginning English letter A indicates the communication terminal A which stores the content data 30, the number 1 is an ordinal number indexing the order of the storage, and the letter M identifies A1M itself as the metadata 20.

The content data storage 3, for instance, is composed of a hard disk which can read/write the content data 30 and stores the content data 30 in a memory area on the hard disk.

### (Configuration of the Communication Terminals A to E)

The communication terminal A located uppermost in the data management system 1 stores a metadata A1M, which is a metadata 20 of a content data A1 stored by itself, and all other metadata B1M, C1M, C2M, D1M, E1M, and E2M, which are metadata 20 respectively stored in the metadata storages 2 of the lower level communication terminals B to E.

The communication terminal B connected to the communication terminal A stores a metadata B1M, which is a metadata 20 of a content data B1 stored by itself, and metadata D1M, E1M, which are metadata 20 respectively stored in the metadata storages 2 of the lower level communication terminals D and E.

The communication terminal C connected to the communication terminal A stores metadata C1M, C2M, which are metadata 20 of content data C1, C2 stored in its own metadata storage 2.

The communication terminal D connected to the communication terminal B stores metadata D1M, which is a metadata 20 of a content data D1 stored in its own metadata storage 2.

The communication terminal E connected to the communication terminal B stores metadata E1M, E2M, which are metadata 20 of content data E1, E2 stored in its own metadata storage 2.

In the first preferred embodiment of the data management system 1, however, a communication terminal, if connected to another communication terminal, is designed to be connected to the other communication terminal only.

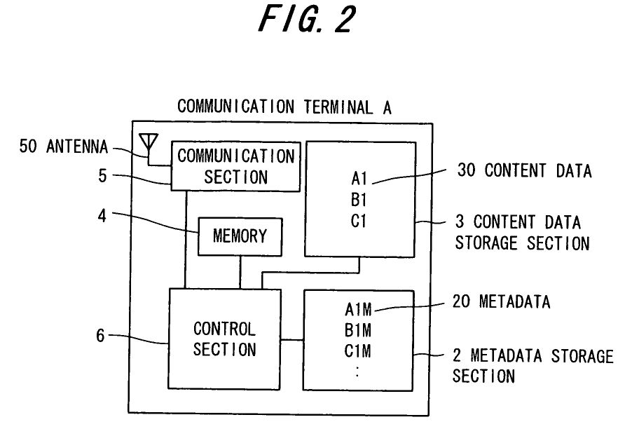

FIG. 2 is a circuit block diagram showing a main section of each communication terminal A to E. Since every communication terminal A to E, as a content data-providing communication terminal, is formed of the same structure regarding its main section, the only communication terminal A will be described in the following description.

The communication terminal A includes a metadata storage 2 to store metadata 20, a content data storage 3 to store content data 30, a memory 4 to store control programs and data required for operations of the communication terminal A, a communication section 5 to perform communication functions of sending/receiving content data 30 and metadata 20, an antenna 50 connected to the communication section 5 to transmit/receive radio waves, and a control section 6 to control each section of the communication terminal A.

The communication section 5 installs a communication interface employing frequency bands of radio waves occupied by wireless-LAN, for example, 2.4 Ghz frequency band of radio wave based on IEEE802.11b standards, and also a communication port (not shown), which can be wired with a communication cable such as an Ethernet(registered trademark) cable.

The control section 6, when the communication terminal A is connected to another communication terminal, the communication terminal A updates the stored metadata 20 and, at the same time, repots the updated metadata 20 to the upper level communication terminal by controlling its communication section 5. Besides, when an addition, deletion, or replacement of a content data 30 stored in the content data storage 3 of the communication terminal A occurs, or when it receives a metadata 20 from another communication terminal connected to itself, the control section 6 of the communication terminal A updates the stored metadata 20 and transmits the updated metadata 20 to an upper level communication terminal by controlling the communication section 5.

In addition the control section 6 has a dependency information storage (not illustrated) to store information on whether the communication terminal A is connected to another communication terminal or not, and, if it is connected to the other communication terminal, the numeral “1”, which is a data to index that the communication terminal A is connected to the other communication terminal, is written in the information storage. If not connected to the other communication terminal, the numeral “0” is written as a data in the dependency information storage, indicating non-dependency.

### (Operation of Storing Metadata in a Communication Terminal)

Next a case wherein a content data D2 gets added to a communication terminal D will be described as an operation of storing metadata 20 in a metadata storage 2.

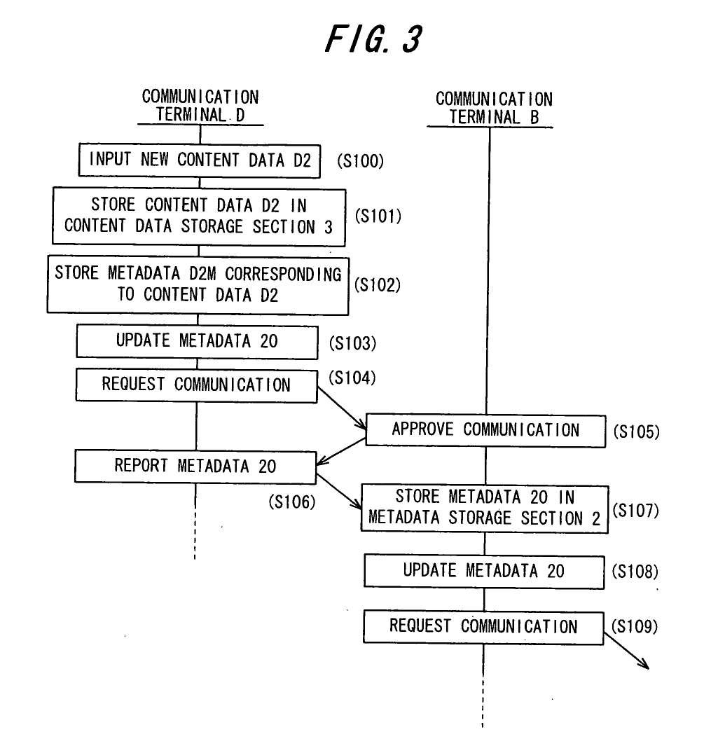

FIG. 3 is a view explaining an operation between the communication terminal B and the communication terminal D. The communication terminal B and the communication terminal D are connected with each other through a wireless network. The communication terminal D, when a new content data D2 is inputted (S100), stores the content data D2 in its content data storage 3 (S101). Then a metadata D2M corresponding to the content data D2 stored in the content data storage 3 gets stored in the metadata storage 2 (S102). The metadata storage 2 updates the metadata 20 existing in the metadata storage 2 based on the storage of the new metadata D2M (S103).

Next the communication terminal D requests a wireless communication with the upper level communication terminal B based on when the metadata 20 is updated (S104).

Next the communication terminal B, when it receives a request of the wireless communication from the communication terminal D, sends a response to the communication terminal D, approving of the communication of the communication terminal B (S105).

Next the communication terminal D transmits its metadata 20 updated through the network to the communication terminal B, based on the approval of the communication received from the communication terminal B (S106).

Next the communication terminal B stores the metadata 20 transmitted from the communication terminal D in the metadata storage 2 (S107). The metadata storage 2 updates the metadata 20 existing in the metadata storage 2 based on the storage of the transmitted metadata 20 (S108). With these steps, the metadata D2M based on the content data D2 stored in the communication terminal D gets added to metadata 20 in the communication terminal B.

Besides, since the communication terminal B is connected to the communication terminal A, the communication terminal B requests a communication of the communication terminal A (S109), and then transmits the metadata 20 to the communication terminal A by executing the operations described in those steps S104-S108.

### (Operation of Adding a New Communication Terminal F)

Next a data management method of adding a new communication terminal F to such a data management system 1 stated above will be described.

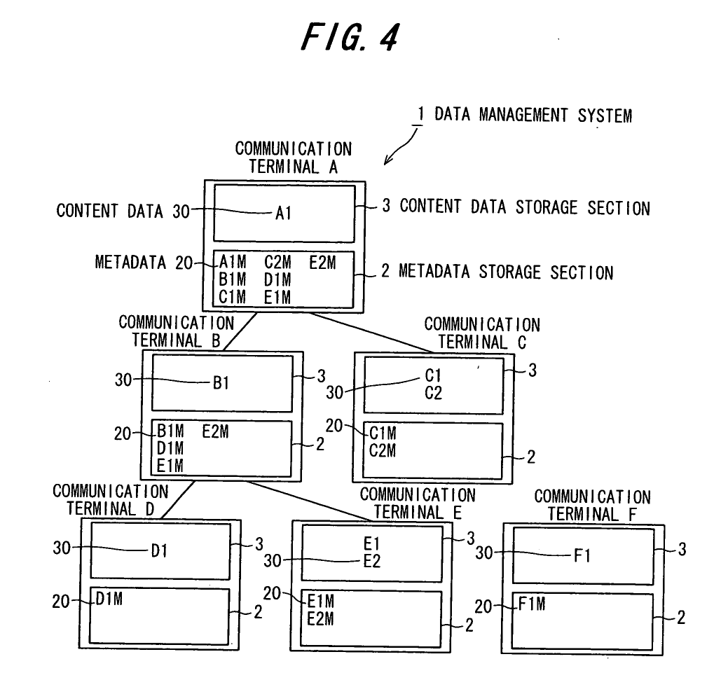

FIG. 4 is a view showing a communication terminal F which newly joins the data management system 1. In FIG. 4, the communication terminal F, for instance, is a laptop personal computer the main section of which has the same structure as that of the communication terminal A as stated above. The communication terminal F stores a content data F1 as a content data 30, in the content data storage 3 and a metadata F1M as a metadata 20 corresponding to the content data F1, in the metadata storage 2.

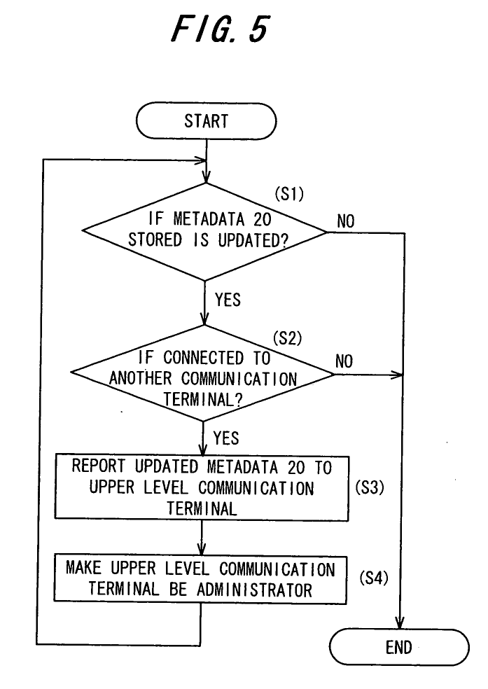

FIG. 5 is a flowchart of an operation in the first preferred embodiment according to the present invention. Processes with regard to from when the communication terminal F newly joins the data management system to when the uppermost communication terminal A obtains metadata 20 of the communication terminal F will be explained as follows.

The communication terminal F, in the event of joining the data management system 1, firstly succeeds in communicating with a communication terminal C and then establishes a protocol necessary to send/receive the data at the control section 6, thereby to be connected to the communication terminal C. The control section 6 of the communication terminal F, when the communication terminal F is connected to the communication terminal C, writes the numeral “1” as a data of dependency, in the dependency information storage. Since the communication terminal F adds a new metadata 20 to the data management system 1 based on the connection, the metadata 20 is considered as updated (S1: YES). Besides, since the communication terminal F is connected to the communication terminal C (S2: YES), it sends the updated metadata 20 to the upper level communication terminal C (S3). At the time the communication terminal C becomes an administrator to manage the metadata 20 (S4). Meanwhile, if the metadata 20 doesn't get updated (S1: NO), or else if the metadata 20 gets updated, but the communication terminal F is not connected to any other communication terminal (S2: NO), no metadata 20 will be transmitted.

Next the communication terminal C, by receiving metadata 20 including a metadata F1M from the communication terminal F, adds the metadata F1M to the metadata 20 stored in the metadata storage 2, so that the metadata 20 is updated (S1: YES). The communication terminal C, since it is connected to the communication terminal A, sends the updated metadata 20 to the upper level communication terminal A (S3). With these steps the communication terminal A becomes an administrator to manage the metadata 20 (S4).

The communication terminal A, by receiving the metadata 20 including the metadata F1M from the communication terminal C, adds the metadata F1M to the metadata 20 stored in the metadata storage 2, thereby to update the metadata 20 (S2: YES). The communication terminal A, since it is located uppermost in the data management system 1, sends the updated metadata 20 to nowhere (S2: NO).

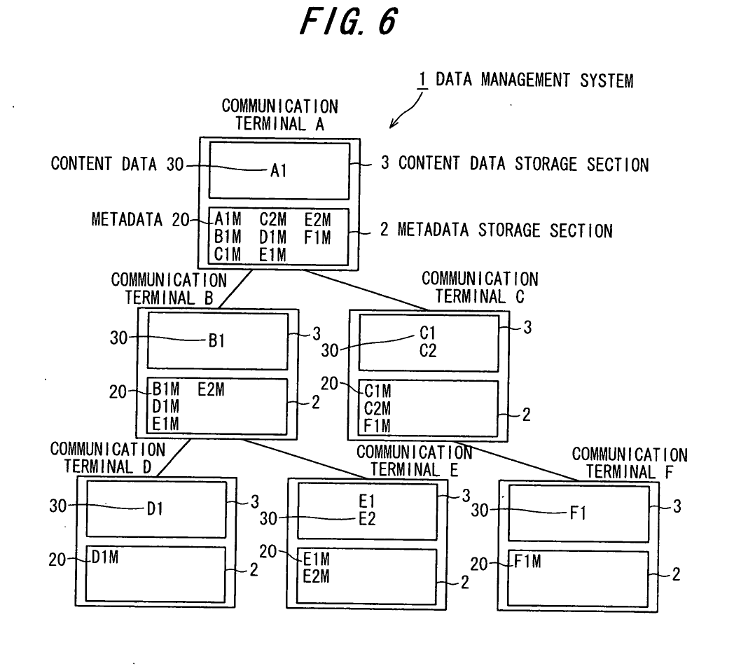

FIG. 6 is a view illustrating a data management system 1 in a state where the metadata F1M of the communication terminal F is stored in the metadata storage 2 of a communication terminal A. The metadata F1M is stored both in the metadata storage 2 of the communication terminal C to which the communication terminal F is connected and in the metadata storage 2 of the communication terminal A to which the communication terminal C is connected.

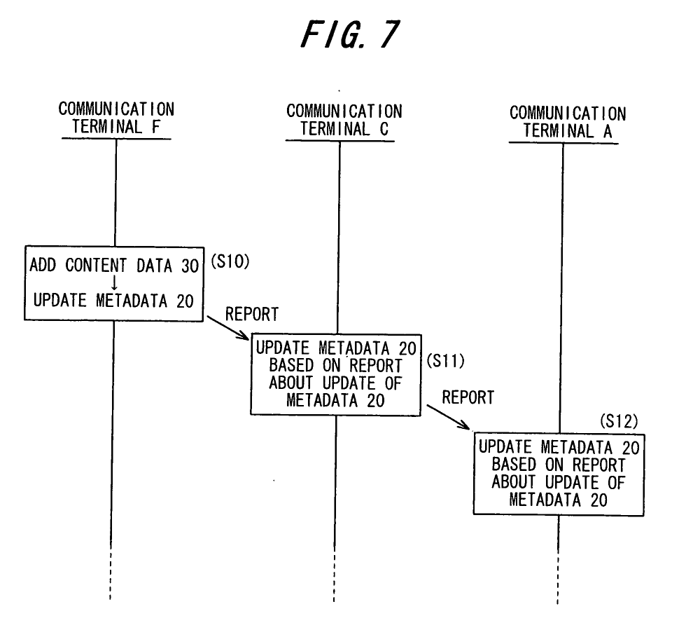

FIG. 7 is a timing chart showing a flow of updating metadata 20 when a new content data 30 gets added to the communication terminal F. In FIG. 7 the communication terminal F, when a new content data 30 gets added to the content data storage 3, updates the metadata 20 stored in the metadata storage 2 based on the metadata corresponding to the content data 30 added anew (S10). Next the communication terminal F transmits the updated metadata 20 to the communication terminal C by wireless. Then the communication terminal C updates the metadata 20 stored in the metadata storage 2 based on the report from the communication terminal F (S11). Next the communication terminal C transmits the updated metadata 20 to a communication terminal A by wireless. Then the communication terminal A updates the metadata 20 stored in the metadata storage 2 based on the report from the communication terminal C (S12). With theses steps the F1M, which is a metadata corresponding to the content data 30 newly added at the communication terminal F is added to the metadata 20 in the communication terminal A, thereby to update the metadata 20 to the latest.

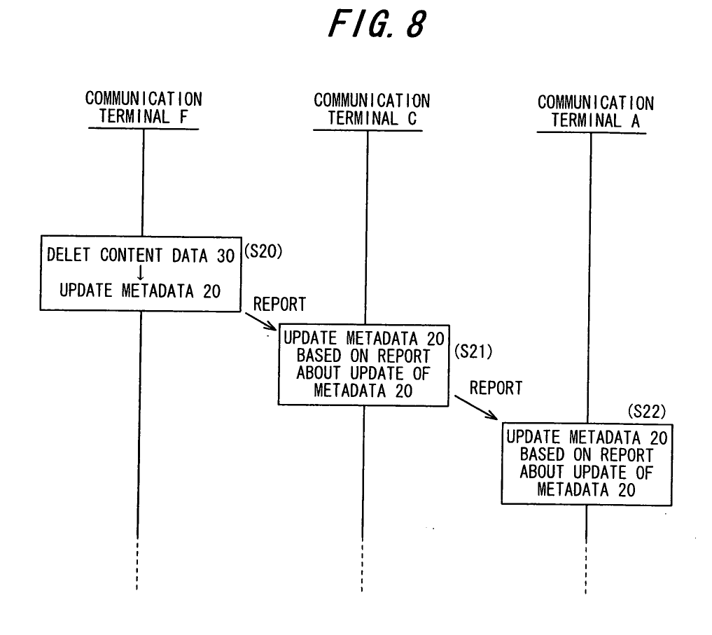

FIG. 8 is a timing chart showing a flow of updating the metadata 20 when the content data 30 stored in the communication terminal F gets deleted. In FIG. 8 the communication terminal F, when the content data 30 stored in the content data storage 3 gets deleted, updates the metadata 20 stored in its metadata storage 2 based on the deletion of the content data 30 (S20). Next the communication terminal F transmits the updated metadata 20 to the communication terminal C by wireless. Then the communication terminal C updates the metadata 20 stored in the metadata storage 2 based on the report from the communication terminal F (S21). Next the communication terminal C transmits the updated metadata 20 to the communication terminal A by wireless. Then the communication terminal A updates the metadata 20 stored in the metadata storage 2 based on the report from the communication terminal C (S22). With these steps the communication terminal A gets the metadata 20 most-updated since the metadata 20 corresponding to the deleted content data 30 is deleted.

### (Advantages of the First Preferred Embodiment)

According to the first preferred embodiment stated above the following advantages will be achieved.

1. When one of the following three cases occurs:
(a) Any of communication terminals A to E is connected to another communication terminal,
(b) An addition, a deletion, or a replacement of a content data 30 at a content data storage 3 is produced,
(c) a metadata 20 is received from a lower level communication terminal connected to another communication terminal, since each communication terminal in the data management system updates the own metadata 20 stored in the own metadata storage 2 and transmits the updated metadata 20 to the upper level communication terminal by wireless, to which the communication terminal is connected, if it is connected to another communication terminal, a most-updated metadata 20 stored in a metadata storage 2 at any of communication terminals A to E gets transmitted to a communication terminal located uppermost in the data management system 1 and stored in the metadata storage 2. And thus, without any troublesome control by metadata management programs, a metadata 20 is stored in the communication terminal A located uppermost in the data management system, whereby an exclusive server device is not necessary and an efficient hierarchical management of metadata 20 is carried out without getting its structure complicated.

2. Since the metadata 20 corresponding to all content data 30 stored in the data management system 1 are stored in the uppermost level communication terminal A, the metadata 20 can be utilized efficiently, and furthermore, it is easy to grasp existence of a desired content data 30 and its location, and it is possible to prevent the content data 30 from getting stored in a plurality of content data storages 3 redundantly.

3. Any of communication terminals A to E, when it needs to grasp existence of a desired content data 30 and its location, by accessing metadata 20 stored in a metadata storage 2 of an upper level communication terminal, can obtain a metadata 20 corresponding to the desired content data 30 even if it is stored in another communication terminal that isn't directly connected to the communication terminal, without inquiring the information of every communication terminal in the data management system 1, and thus it is easy to grasp existence of the desired content data 30 and its location.

4. Besides, since a communication terminal doesn't need to inquire for every communication terminal in the data management system 1 when retrieving a metadata 20, the time for establishment of a connection, disconnection, and re-connection can be shortened, and thus the metadata 20 can be obtained speedily.

The first preferred embodiment of the data management system 1 describes a structure wherein every communication terminal communicates with each other by wireless. However, other than wireless-LAN, a wireless communication based on other communication standards such as Bluetooth (registered trademark), IrDA (Infrared DATA Association), and so on, can be used. In addition all or some of the communication terminals can be wired each other by USB (Universal Serial Bus), Ethernet (registered trademark) cables and so on.

Moreover the metadata storage 2 and the content data storage 3 may be formed of a storage device other than a hard disk, for instance, a semiconductor memory such as a RAM (Random Access Memory).

### Second Preferred Embodiment

### (Configuration of a Data Management System)

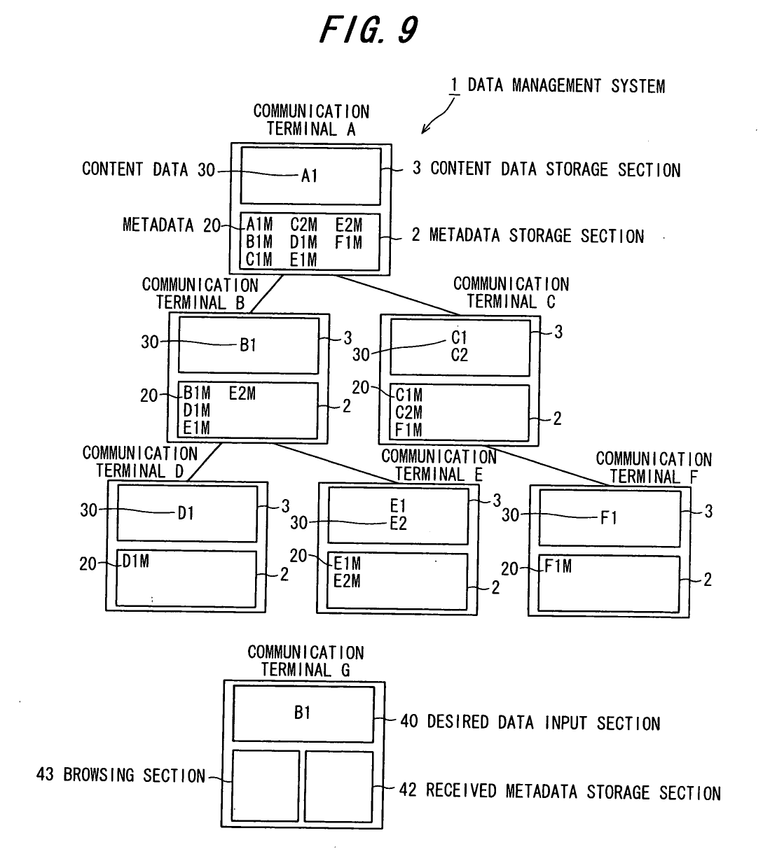

FIG. 9 is an entire view showing a data management system 1 with communication terminals in a second preferred embodiment according to the present invention. The second preferred embodiment, with a browser communication terminal G connected to the data management system 1 described in FIG. 6, enables users to browse a desired content data.

FIG. 9 shows that the communication terminal G includes a desired data input section 40 with input devices such as a keyboard, a mouse, or the like, which input information on a desired content data 30, a received metadata storage 42, which receives and stores all the metadata 20 from the data management system 1, and a browsing section 43 with playback devices such as an LCD (liquid Crystal Display), speakers, and the like, required for browsing a received content data 30.

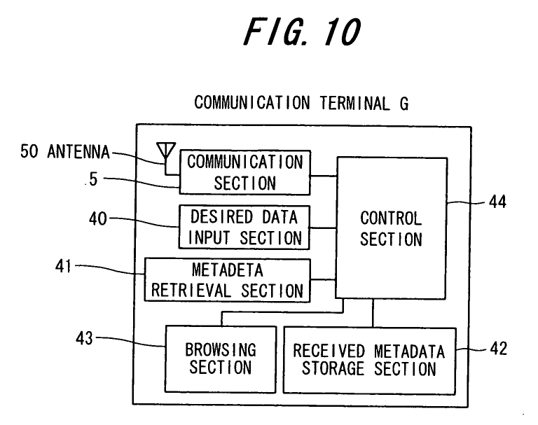

FIG. 10 is a circuit block diagram showing the main section of the communication terminal G. The communication terminal G, other than the sections shown in FIG. 9, includes a metadata retrieval section 41, which retrieves the metadata 20 in the data management system 1 based on the information on the desired content data inputted at the desired data input section 40, a communication section 5 which performs a communication function to receive the content data 30 and the metadata 20, an antenna 50 connected to the communication section 5, which transmits/receives radio waves, and a control section 44, which controls each section of the communication terminal G.

The control section 5 includes the same communication interface as the one described in the first embodiment, which employs 2.4 Ghz frequency band of radio wave and is provided with a communication function enabling a direct peer-to-peer connection with a communication terminal storing a desired content data 30.

The control section 44 has a control function enabling the metadata retrieval section 41 to implement retrieval of metadata 20 at each of the communication terminals A to F connected to the data management system 1, and obtains all the metadata available from the data management system 1, and then stores them in the received metadata storage 42.

### (Operation of Browsing Content Data)

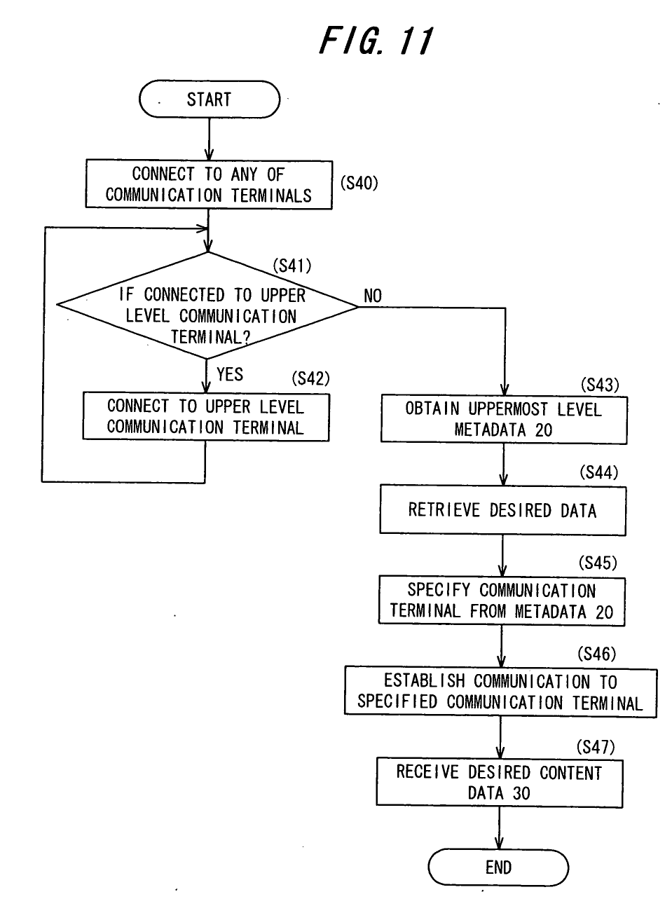

FIG. 11 is a flowchart of an operation in the second preferred embodiment according to the present invention. The following will explain steps of the flow on from when the communication terminal G is connected to the data management system 1 and to when the communication terminal G utilizes the content data 30.

First the communication terminal G communicates with one of the communication terminals connected to the data management system 1. At the time, if it succeeds in wirelessly communicating with the communication terminal E, the control section 44 of the communication terminal G, by establishing a protocol required for sending/receiving data, is connected to the communication terminal E (S40).

Next the control section 44 of the communication terminal G judges whether the communication terminal E is connected to another communication terminal based on the dependency information stored in the dependency information storage of the control section 6. Herein, since the communication terminal E is connected to the upper level communication terminal B, the numeral showing the dependency information is “1” (S41: YES), which means that the communication terminal E doesn't obtain the uppermost level metadata 20 yet(S41: YES).

Next the communication terminal G communicates with the communication terminal B through the communication terminal E (S42). Then the control section 44 of the communication terminal G judges whether the communication terminal B is connected to another communication terminal based on the dependency information stored in the dependency information storage of the control section 6. Herein, since the communication terminal B is connected to the upper level communication terminal A, the numeral showing the dependency information is “1” (S41: YES), which means that the communication terminal B doesn't obtain the uppermost level metadata 20 yet (S41: YES).

Next the communication terminal G communicates with the communication terminal A through the communication terminals E and B (S42). Then the control section 44 of the communication terminal G judges whether or not the communication terminal A is connected to another communication terminal based on the dependency information stored in the dependency information storage 6. Herein, the numeral showing the dependency information of the communication terminal A is “0”, which means that the communication terminal A is connected to none of other upper level communication terminals (S41: NO). At the moment the communication terminal G hasn't yet obtained the uppermost level metadata 20.

Next the communication terminal G obtains the uppermost level metadata 20 stored in the metadata storage 2 of the communication terminal A and then stores them in the received metadata storage 42 (S43).

Next the control section 44 of the communication terminal G gets the metadata retrieval section 41 to retrieve the metadata 20 stored in the received metadata storage 42 based on a data indexing the content data 30 inputted in the desired data input section 40.

The metadata retrieval section 41 retrieves the metadata 20 corresponding to the desired content data 30 from the uppermost level metadata 20 stored in the received metadata storage 42 (S44), and if the desired content data exists in the data management system 1, specifies which communication terminal includes the content data (S45), and repots it to the control section 44.

The control section 44, when it receives the repot on the communication terminal storing the desired content data 30 from the metadata retrieval section 41, establishes a peer-to-peer wireless communication to the communication terminal storing the desired content data 30 (S46), and then receives the desired content data 30 through the communication section 5 (S47). The received content data 30 gets outputted to the browse section 43. The browsing section 43 plays back the received content data 30 with the playback device.

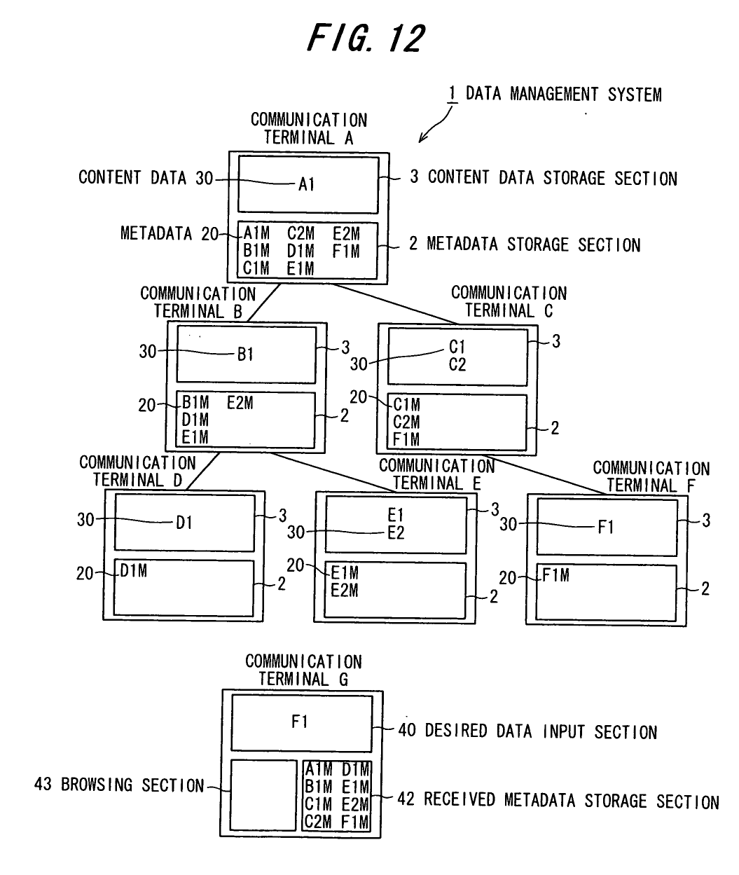

FIG. 12 is a view showing a state where the communication terminal G is connected to a communication terminal F by peer-to-peer with the uppermost metadata 20 stored in its received metadata storage 42. In the following section a peer-to-peer communication between the communication terminal F and the communication terminal G, when a content data F1 as an image content data is inputted at the desired data input section 40 of the communication terminal G, will be described.

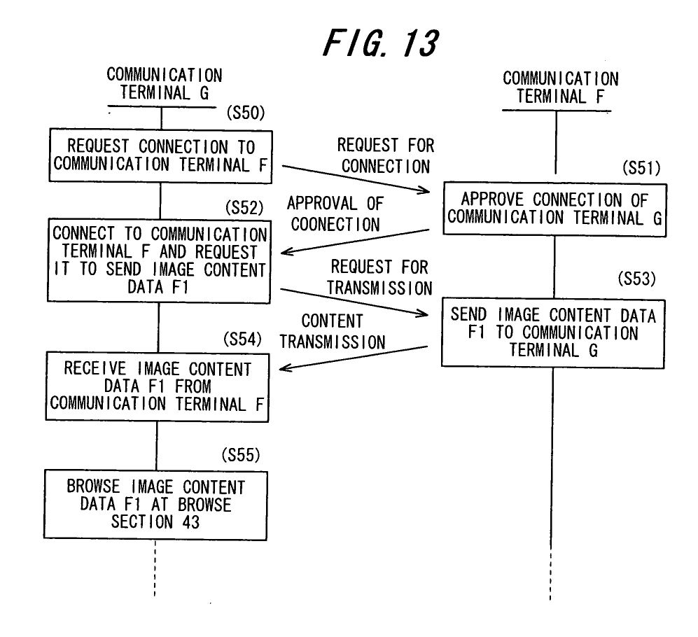

FIG. 13 is a peer-to-peer communication flow between the communication terminal G and the communication terminal F. Firstly the communication terminal G requests a wireless peer-to-peer connection to the communication terminal F (S50). The communication terminal F, if the connection requested by the communication terminal G is approved, wirelessly reports the approval of the connection (S51). Next the communication terminal G, from its desired data input section 40, asks the communication terminal F to send the image content data F1 (S52) The communication terminal F, by responding to the request from the communication terminal G, sends the image content data Fl to the communication terminal G (S53). The communication terminal G receives the image content data F1 from the communication terminal F (S54). The control section 44 of the communication terminal G outputs the image content data F1 received from the communication terminal F, to the browsing section 43. The browsing section 43 displays the received image content data F1 on its LCD, so that the image content data F1 can be browsed (S55).

### (Advantages of the Second Preferred Embodiment)

According to the second preferred embodiment stated above the following advantages will be achieved.

1. Since the uppermost level metadata 20 is obtained by the communication terminal G which is connectable with any of the communication terminals connected to the data management system 1 described in the first embodiment and the communication terminal G receives the content data 30 from the communication terminal storing the desired content data 30 based on the obtained metadata 20, it is easy and speedy to grasp the existence and the location of the content data 30 stored in the data management system 1, and the content data can be smoothly shared.

2. A direct peer-to-peer connection allowing communication terminals to communicate with a communication terminal storing the desired content data 30 without passing through other communication terminals, enables the content data 30 to be received with supreme quality, and eliminates speed-down of the communication caused by transmission capacity of in-between devices, and thus a speedy communication can be performed.

The second preferred embodiment describes a structure in which the communication terminal G obtains the uppermost level metadata 20 from the communication terminal A connected to the data management system 1. However, another structure, for instance, a case in which the communication terminal G reaches the uppermost level communication terminal A as it stores metadata 20 stored in the metadata storage 2 in the communication terminals B and E in order, may be considered. This structure enables the communication terminal G to obtain the metadata 20 stored in the communication terminals on its way to the communication terminal B, the substantial uppermost, even if the uppermost level communication terminal cannot be specified based on the dependency information stored in the dependency information storage in each of the communication terminals A to F, that is, the communication terminal A, of which dependency information is “0”, is inaccessible due to communication malfunction.

In the second preferred embodiment, first, the uppermost level metadata 20 gets stored in the received metadata storage 42 of the communication terminal G and then the metadata retrieval section 41 retrieves the metadata 20 based on an index data concerning the content data 30 inputted at the desired data input section 40. However, another case may be considered that, first, an index data of the desired content data 30 gets inputted at the desired data input section 40 and then the metadata 20 will be obtained from every communication terminal connected to the data management system 1 in order. In this case, since the communication terminal G can complete the process of obtaining the metadata 20 when the metadata 20 corresponding to the desired content data 30 is retrieved, the time required for obtaining metadata 20 and the memory area of the received metadata storage 42 can be saved.

### INDUSTRIAL APPLICABILITY

As described above, without any complex control by metadata management programs, a metadata 20 is stored in the communication terminal A located uppermost in the data management system, whereby an exclusive server device is not necessary and an efficient hierarchical management of metadata 20 is carried out without getting its structure complicated. As a result, metadata corresponding to content data respectively stored in plural communication terminals can be retrieved easily.

1. A data management system, comprising:
a first communication terminal including:
a first content data storage which stores a first content data; and
a first related data storage which stores a first related data corresponding to the first content data; and
a second communication terminal including:
a second content data storage which stores a second content data; and
a second related data storage which stores the first related data received from the first communication terminal through a network and a second related data corresponding to the second content data.

2. The data management system according to claim 1, further comprising:
the first communication terminal updates the first related data based upon receiving a related data from the other communication terminal;
the first communication terminal sends the updated first related data to the second communication terminal as an upper level communication terminal connected to the first communication terminal; and
the second communication terminal updates the second related data stored in the second related data storage based upon the updated first related data from the first communication terminal, whereby
the other related data stored in the other communication terminal is stored in the first communication terminal, as well as in the second communication terminal.

3. The data management system according to claim 1, wherein:
the first communication terminal includes a plurality of communication terminals connected in parallel to the second communication terminal through the network.

4. The data management system according to claim 1, wherein:
the first communication terminal includes a plurality of communication terminals connected in series to the second communication terminal through the network.

5. The data management system according to claim 1, wherein:
a communication between the first communication terminal and the second communication terminal is performed by wireless connections.

6. The data management system according to claim 1, wherein:
a communication between the first communication terminal and the second communication terminal is performed by wired connections.

7. A data management system, comprising:
a group of a plurality of communication terminals connected with each other; and
a browsing communication terminal to be connected to one communication terminal of the group, wherein:
the browsing communication terminal is connected to an uppermost level communication terminal of the group through the one communication terminal and a communication terminal between the one communication terminal and the uppermost level communication terminal;
the browsing communication terminal retrieves a related data corresponding to a desired content data from the related data stored in the uppermost communication terminal to identify a communication terminal of the group which stores the desired content data; and
the browsing communication terminal communicates with the identified communication terminal to receive the desired content data, and then plays back the desired content data.

8.-10. (canceled)

11. A communication terminal, comprising:
a content data storage to store content data; and
a related data storage to store the related data corresponding to the content data;
a communication section to send and receive the related data with other communication terminals;
a control section to control the communication section wherein:
the control section, when the other communication terminal is connected to the communication terminal, updates the related data stored in the related data storage, and transmits the updated related data to an upper level communication terminal by controlling the communication section.

12. The communication terminal as defined in claim 11, wherein:
the control section includes a dependence information memory section to store information whether or not the another communication terminal is connected to the communication terminal.

13. A communication terminal, comprising:
a related data storage to store related data corresponding to a content data;
an input section to input retrieval information of the desired content data for browsing;
a related data retrieval section to retrieve the related data stored in the related data storage based on the retrieval information; and
a browsing section to browse the content data corresponding to related data retrieved by the related data retrieval section.

14. A communication terminal, comprising:
a related data storage to store related data corresponding to a content data;
an input section to input retrieval information of the desired content data for browsing;
a related data retrieval section to retrieve the related data stored in the related data storage based on the retrieval information;
a browsing section to browse the content data corresponding to related data retrieved by the related data retrieval section;
a communication section to receive the content data and the related data through a network; and
a control section to control the communication of the content data based on the retrieved related data.

15. The communication terminal according to claim 13, wherein:
the browsing section connects by peer-to-peer to a communication terminal to store the content data through the network.

16.-20. (canceled)
